(19) United States
(12) Patent Application Publication
(10) Pub. No.: US 2006/0046762 A1
(43) Pub. Date: Mar. 2, 2006

(54) System and method for controlling congestion between response messages responsive to a group call page in a mobile communication system

(75) Inventors: Seung-Il Yoon, Seongnam-si (KR); In-Ky Cho, Hwaseong-si (KR); Jae-Hyok Lee, Seoul (KR); Dong-Keon Kong, Suwon-si (KR); Sung-Kwon Jo, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/210,674

(22) Filed: Aug. 25, 2005

(30) Foreign Application Priority Data
Aug. 27, 2004 (KR) 2004-68173

(51) Int. Cl. H04B 7/00; H04Q 7/20

(52) U.S. Cl. 455/519

(57) ABSTRACT

A system and method for controlling congestion between response messages responsive to a group call page in a mobile communication system are provided. Efficient group call control is accomplished by transmitting a group call page message comprising a group call identifier to an access terminal through a control channel, and at the access terminal receiving the group call page message, applying a different response time according to a reception type of the group call page message to transmit a response message to the access network transceiver system.

### CLAIM OF PRIORITY

This application claims the benefit under 35 U.S.C. § 119(a) of an application filed in the Korean Intellectual Property Office on 27 Aug. 2004 and assigned Serial No. 2004-68173, the entire contents of which are hereby incorporated by reference.

### BACKGROUND OF THE INVENTION

1. Field of the Invention

The present invention relates to group call control in a mobile communication system. More particularly, the present invention relates to a system and method for controlling congestion between response messages responsive to a group call page in a mobile communication system, which can control congestion when transmitting a page message for a push-to-talk (PTT) group call and transmitting response messages from access terminals in a code division multiple access (CDMA) 2000 first evolution data only (1x EV-DO) system.

2. Description of the Related Art

Code division multiple access (CDMA) 2000 first evolution data only (1x EV-DO) is a mobile communications technology originally called high data rate (HDR) by Qualcomm, Inc., and selected for standardization by the third generation partnership project 2 (3GPP2) committee. A standardized prototype of the CDMA2000 1x EV-DO system was issued on December of 2000, its official name is high rate packet data system (HRPD). The CDMA2000 1x EV-DO system provides a data service only.

The protocol layer of the CDMA2000 1x EV-DO system comprises an application layer, a stream layer, a session layer, a connection layer, a security layer, a medium access control (MAC) layer, and a physical layer.

The application layer comprises a signaling application and a packet application. The signaling application is used to process control information necessary for a call processing, and the packet application is used for transmission of actual user data.

The stream layer multiplexes different application streams and classifies application streams according to quality of service (QoS) levels. The session layer performs functions such as address management, protocol negotiation, and protocol structure and status management.

The connection layer establishes or maintains a wireless protocol between an access terminal and an access network transceiver system (ANTS). The security layer performs authentication and encryption functions. The MAC layer defines transmission methods and procedures of the physical layer. The physical layer performs functions such as channel structure and frequency coding and modulation.

Of these layers, the MAC layer has a forward protocol comprised of a control channel MAC protocol and a forward traffic channel MAC protocol, and a reverse protocol comprised of an access channel MAC protocol and a reverse traffic channel MAC protocol.

The control channel MAC protocol is used to transmit various control information of a higher layer, and the control channel has a transmission period of a 256 slot unit and has a control channel header which contains a synchronous capsule and a last packet which are respectively one bit, a 2-bit offset, and a 4-bit reserved field.

The CDMA2000 1x EV-DO system can designate a sub-synchronous control channel capsule (SSC) to respective access terminals to distribute a time for transmitting page messages to respective access terminals and a time for receiving response messages thereto. However, if a plurality of access terminals registered as one group belong to the same sector like in a group call or 1:N call, it is necessary to transmit discrete page messages from a PTT server to respective access terminals via an access network controller (ANC) and allocate discrete traffic resources. Consequently, this method is inefficient.

A PTT group call has the feature that access terminals which join the same group call can share one traffic resource in the same sector and it is possible to page all access terminals using one group ID rather than performing an individual page. This method has the effect of preventing inefficient use of page messages and sharing traffic resources, thereby increasing resource availability.

One of the most important things in this method is to know how many access terminals are located in the same sector. If the number of access terminals located in the same sector is known, it is possible to determine whether to allocate a traffic resource individually or to establish one group traffic channel.

For this purpose, there is a method for reporting a location change by continuously tracking or monitoring the locations of access terminals. However, this method has a disadvantage in that battery consumption is relatively high while accuracy is low. Alternatively, there is a method for receiving a response message regarding a message for checking the location of an access terminal before transmitting a group call page message to thereby determine whether the access terminal is located in the same sector and how many access terminals are located in the same sector. Here, the location-check message is transmitted via a slot monitored by all access terminals, and thus there is a possibility of congestion between access terminals transmitting the location-check response message.

Since the SSC has a transmission period of 64 slots, compared to the existing synchronous control channel capsule (SC), fast general or group calling is possible. If access terminals monitoring the same SSC simultaneously perform access transmission for transmitting a message for setting up a packet call or some other message, the probability of failure increases.

### SUMMARY OF THE INVENTION

It is an exemplary object of the present invention to provide a system and method for controlling congestion between response messages responsive to a group call page in a mobile communication system, in which all access terminals monitor the same sub-synchronous control channel capsule (SSC) to facilitate easy push to talk (PTT) group call paging, thereby controlling congestion which occurs when access terminals located in the same sector receive the group call page message and transmit the response messages.

According to an exemplary aspect of the present invention, a method is provided for controlling congestion between response messages responsive to a group call page in a mobile communication system. The method comprises transmitting a group call page message comprising a group call identifier to at least one group call paging target access terminal through a control channel, receiving the group call page message at the at least one access terminal, and applying, at the at least one access terminal, a different response time according to a reception type of the group call page message and transmitting a response message to an access network transceiver system.

The group call identifier may be included in at least one of a page message, a location check request message RouteUpdateRequest, and a DataOverSignaling message, and transmitted to the access terminal. The group call identifier may comprise a multicast access terminal identifier (MATI).

The group call page message may be transmitted to the access terminal through a sub-synchronous control channel capsule (SSC).

The group call page message may be transmitted to all of the group call paging target access terminals through one SSC designated for a group call page among SSC slots included in one control channel period. In the response message transmitting step, a fixed transmission delay time (APersistence) value received from the access network transceiver system may be changed into a random value by the access terminal, so that the response message is transmitted to the access network transceiver system at a different access time from other access terminals.

In the group call paging step, one of SSC slots included in one control channel period may be designated as a SSC slot for a group call page and the group call page message may be transmitted through the designated SSC slot. In the group call page message receiving step, the access terminal may monitor only the SSC slot designated to itself to receive the group call page message. In the group call page message receiving step, the access terminal may monitor all SSC slots but receive the group call page message only through its own designated SSC slot.

The SSC slot for the group call page may be designated for respective access terminals using a value obtained using a unicast access terminal identifier (UATI) as a factor of a hash function.

The method may further comprise transmitting a stop request message for requesting the at least one access terminals which is in the process of preparing transmission of the response message to stop transmission of the response message when the access network transceiver system in receipt of the response message from the at least one access terminal performs a group call page.

The stop request message may be added to an AC Ack message of an asynchronous control channel capsule (AC) and then transmitted to the access terminal.

According to another exemplary aspect of the present invention, a method is provided for controlling congestion between response messages responsive to a group call page in a mobile communication system. The message comprises group call paging comprising transmitting a group call page message comprising a group call identifier to at least one group call paging target access terminal through a control channel with a time difference, group call page message receiving comprising receiving the group call page message at the at least one access terminal, response message transmitting comprising transmitting, at the at least one access terminal, a response message to an access network transceiver system according to a reception type of the group call page message, transmitting a stop request message for requesting the at least one access terminal which is in the process of preparing transmission of the response message to stop transmission of the response message when the access network transceiver system in receipt of the response message from the at least one access terminal performs a group call page; and canceling transmission of the group call page response message at the at least one access terminal in receipt of the stop request message.

According to still another exemplary aspect of the present invention, a method is provided for controlling congestion between response messages responsive to a group call page in a mobile communication system. The method comprises group call paging comprising transmitting, at an access network transceiver system, a group call page message comprising a group call identifier to an access terminal through a control channel, and response message transmitting comprising applying, at the at least one access terminal in receipt of the group call page message, a different transmission delay value from other access terminals and transmitting a response message to the access network transceiver system.

According to yet another exemplary aspect of the present invention, a mobile communication system is provided. The system comprises an access network transceiver system for transmitting a group call page message comprising a group call identifier to at least one group call paging target access terminal through a control channel, and at least one access terminal for receiving the group call page message and applying a different response time from other access terminals according to a reception type of the received group call page message and transmitting a response message to the access network transceiver system.

The access network transceiver system may transmit the group call page message to all of the group call paging target access terminals through one SSC designated for a group call page among SSC slots included in one control channel period, and all of the group call paging target access terminals may monitor the SSC slot designated for the group call to receive the group call page message.

The access network transceiver system may designate one SSC slot for each access terminal as a SSC slot for a group call page and transmits the group call page message to the access terminals through the designated SSC slots, and each access terminal monitors only the SSC slot designated for itself to perceive whether the group call page message is received. The access terminal may monitor all SSC slots but receive the group call page message only through its own designated SSC slot.

The access network transceiver system may transmit a stop request message for requesting the at least one access terminal which is in the process of preparing transmission of the response message to stop transmission of the response message when the access network transceiver system in receipt of the response message from the at least one access terminal decides to perform a group call page.

According to yet another exemplary aspect of the present invention, an access terminal is provided for controlling congestion in a mobile communication system which supports a group call. The access terminal receives a group call page message from an access network transceiver system, and changes a fixed transmission delay time value received from the access network transceiver system to a random value to transmit a group call page response message to the access network transceiver system at a different access time from other access terminals.

According to yet another exemplary aspect of the present invention, an access network transceiver system is provided for a mobile communication system which supports a group call. The access network transceiver designates one of SSC slots included in one control channel period as a SSC slot for a group call page and transmitting a group call page message comprising a group call identifier through the designated SSC slot to at least one group call paging target access terminal to perform a group call page.

The access network transceiver system may designate one SSC slot for each access terminal as a SSC slot for a group call page and transmit the group call page message to the access terminals through the designated SSC slot.

The access network transceiver system may transmit a stop request message for requesting the at least one access terminal which is in the process of preparing transmission of the response message to stop transmission of the response message if the access network transceiver system receives the response message from the at least one access terminal and decides to perform a group call page.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a schematic diagram of an exemplary code division multiple access (CDMA) 2000 first evolution data only (1x EV-DO) system according to an exemplary embodiment of the present invention.

FIG. 2 shows a configuration of an exemplary control channel capsule according to an exemplary embodiment of the present invention;

FIG. 3 shows an exemplary access probe sequence of an access channel according to an exemplary embodiment of the present invention;

FIG. 4 is a diagram illustrating an exemplary group call paging method for applying different transmission delay values to respective access terminals (ATs) according to an exemplary embodiment of the present invention;

FIG. 5 shows an exemplary control channel for distributing a congestion risk according to an exemplary embodiment of the present invention;

FIG. 6 is a diagram illustrating an exemplary group call paging procedure according to an exemplary embodiment of the present invention;

FIG. 7 shows an exemplary control channel according to an exemplary embodiment of the present invention;

FIG. 8 shows an exemplary control channel for a group call page response message transmission stop request according to an exemplary embodiment of the present invention;

FIG. 9 is a diagram illustrating an exemplary procedure for requesting a stop of the group call page response message transmission to ATs in a process of preparing for transmission of the group call page response message according to an exemplary embodiment of the present invention; and

FIG. 10 shows an exemplary structure of an AC Ack message used for the group call page response message transmission stop request according to an exemplary embodiment of the present invention.

### DETAILED DESCRIPTION OF EXEMPLARY EMBODIMENTS

The present invention will now be described more fully hereinafter with reference to the accompanying drawings, in which exemplary embodiments of the invention are shown. This invention may, however, be embodied in different forms and should not be construed as limited to the exemplary embodiments set forth herein. In the drawings, the thickness of layers and regions are exaggerated for clarity.

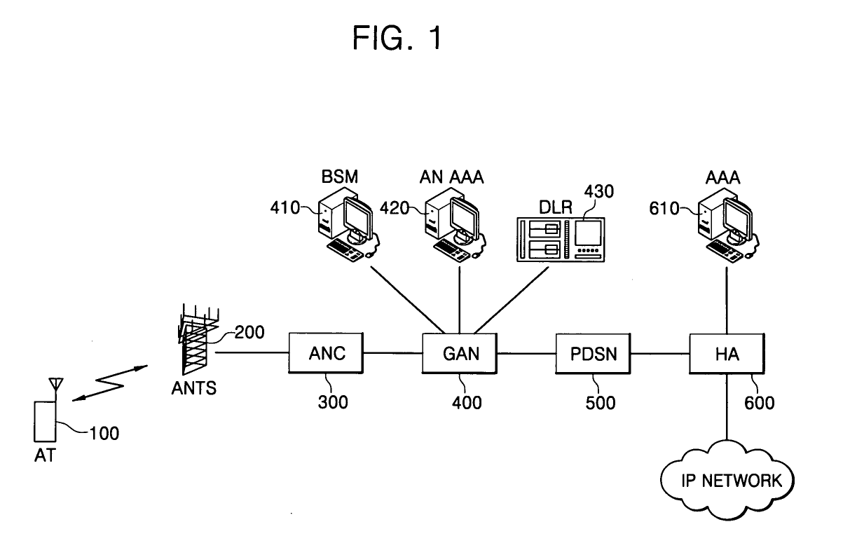

FIG. 1 is a schematic diagram illustrating a code division multiple access (CDMA) 2000 first evolution data only (1x EV-DO) system according to an exemplary embodiment of the present invention.

The CDMA2000 1x EV-DO system of FIG. 1 is a mobile communication system for high rate data transmission and comprises an access terminal (AT) 100, an access network transceiver system (ANTS) 200 which wirelessly communicates with the AT 100, an access network controller (ANC) 300 which controls the ANTS 200, and a conventional Asynchronous Transfer Mode (ATM) switch network (GAN) 400 which connects the ANC 300 to peripheral devices. The GAN 400 is interworked or interconnected with a base station manager (BSM) 410 through which an operator manages the ANTS, an access network authentication, authorization and accounting (AN AAA) module 420 which performs authentication of the AT 100, and a data location register (DLR) 430. The CDMA2000 1x EV-DO of FIG. 1 further comprises a packet data serving node (PDSN) 500 which is interworked with the GAN 400, and a home agent 600 connected to the PDSN 500. The home agent 600 is also connected to an authentication, authorization and accounting (AAA) module 610 and an IP network.

Although not shown, the ANTS 200 is connected to at least one AT 100, the ANC 300 is connected to at least one ANTS 200, and the GAN 400 is also connected to at least one ANC 300. The DLR 430 may cover at least one GAN region or a plurality of DLRs may be connected to one GAN.

This exemplary embodiment of the present invention provides a method for allocating a multicast access terminal identifier (MATI) to respective groups to perform group call paging, a method for making the ATs monitor the same SSC, a method for making the AT randomly apply an access message transmission delay time, a method for making the AT monitor one SSC within one CC period, a method for using one slot of three SSCs monitored by the AT as a group call page slot, and a method for making the ANTS request stop of group call page response message transmission.

A method for allocating a MATI to respective groups when performing a group call page in a mobile communication system is described below.

In order to set up a group call such as a PTT group call, instead of transmitting individual page messages to a plurality of receiving ATs, it is more efficient to page all the ATs through one page message using a group call identifier.

In the CDMA2000 1x EV-DO, as the group call identifier, a MATI is designated to respective groups, and when the AT logs into the PTT server to receive group information, the MATI designated to respective groups is transmitted together.

The CDMA2000 1x EV-DO defines, as an access terminal identifier (ATI) for identifying an access terminal, a broadcast ATI (BATI), a multicast ATI (MATI), a unicast ATI (UATI), and a random ATI (RATI). The BATI is defined as “00”, the MATI is defined as “01”, the UATI is defined as “10”, and the RATI is defined as “11”. The three ATI types excluding the BATI have a 32-bit field for representing an ATI. The UATI is used in a 1:1 call processing procedure.

In this exemplary embodiment of the present invention, if a 1:N group call setup is needed (actually, it is performed in the PTT service), the PTT server transmits a MATI of a corresponding group together while requesting a group call page from the ANTS. If the AT receives a MATI instead of a UATI, the AT recognizes it as a group call page from the system and then performs a group call setup procedure if there is a group registered by the AT's user corresponding to a received MATI.

The MATI can be transmitted through an addressing portion of a page message, a location check request message RouteUpdateRequest, or a DataOverSignaling message broadcast over a control channel. That is, the address portion of the page message, the location check request message, or the DataoverSignaling message should be set to a multicast other than a unicast.

The page message is a message through which the ANTS instructs the AT to perform a connection request, and the location check request message RouteUpdateRequest is a message through which the ANTS instructs the AT to transmit a location check response message. The AT in receipt of the location check request message transmits the location check response message. The location check response message contains a currently received pilot set and status thereof (e.g., field strength and channel information) and is used in a similar manner as a pilot strength measurement message (PSMM) defined in IS-2000. The DataoverSignaling message provides a higher layer packet transmission and duplication perception function.

A case where the ANTS performs a group call page using the MATI, and a plurality of ATs which are located within a coverage area of a corresponding ANTS are set to monitor the same SSC in order to detect a group call page, will be examined below.

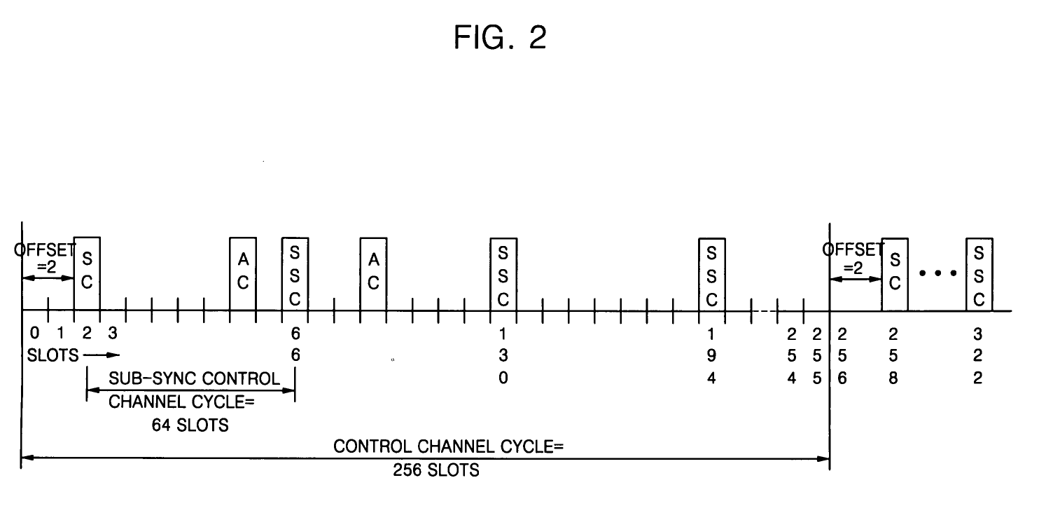

FIG. 2 shows an exemplary configuration of a control channel capsule according to an exemplary embodiment of the present invention.

The control channel is transmitted for a total of 256 slots, and as a control channel capsule there are a synchronous control channel capsule (SC), an asynchronous control channel capsule (AC), and a sub-synchronous control channel capsule (SSC).

The control channel capsule is largely classified into the SC and AC. In the SC, one SC is regularly transmitted at a period of 256 slots, whereas the AC is transmitted at random.

The SC is first transmitted at a time “T mod 256=Offset”, and then retransmitted at a time “T mod 4=Offset”, where T denotes a system time and an Offset denotes a time value delayed from a fixed time, which are included in the control channel header.

One SC can comprise a plurality of control channel MAC layer packets, but one AC comprises only one control channel MAC layer packet. Since each sector (or ANTS) periodically transmits the control channel MAC layer packet, if all the ANTS transmit at the same time, a problem may result. Accordingly, a different offset is applied to the SC for each ANTS.

Meanwhile, as shown in FIG. 2, the ANTS can transmit three SSC capsules within one control channel period. Here, one SSC can transmit only one control channel MAC layer packet. The SSC is used only when the ANTS has a message or data to send to the AT and is a control capsule which is optionally transmitted when the ANTS has no message or data to send.

Referring to FIG. 2, it can be seen that the SSCs are located in 66^{th}, 130^{th}, and 194^{th} slots, if an offset value is 2. That is, a period of the SSC is 64 slots. The AT can receive the SSC through the 66^{th}, 130^{th}, and 194^{th} slots.

In order to support a case of paging a plurality of ATs in the same sector through one page message with the MATI or a group IP like a PTT group call, all ATs are set to monitor the same SSC. To this end, an offset value of all ATs which designates a SC starting location is set to the same value.

A method by which respective ATs randomly apply an access message transmission delay time in order to avoid congestion and connection failure when many ATs access ANTS at the same time and all ATs monitor the same SSC and respond to it as described above will be examined below.

First, when an AT which is to receive the group call page message is about to transmit a paging response message, the AT needs to perceive how many ATs desiring a paged group call are located in the same sector. To this end, the ANTS receives a paging response message from the AT. However, when a plurality of ATs transmit the paging response message at the same time, congestion can occur.

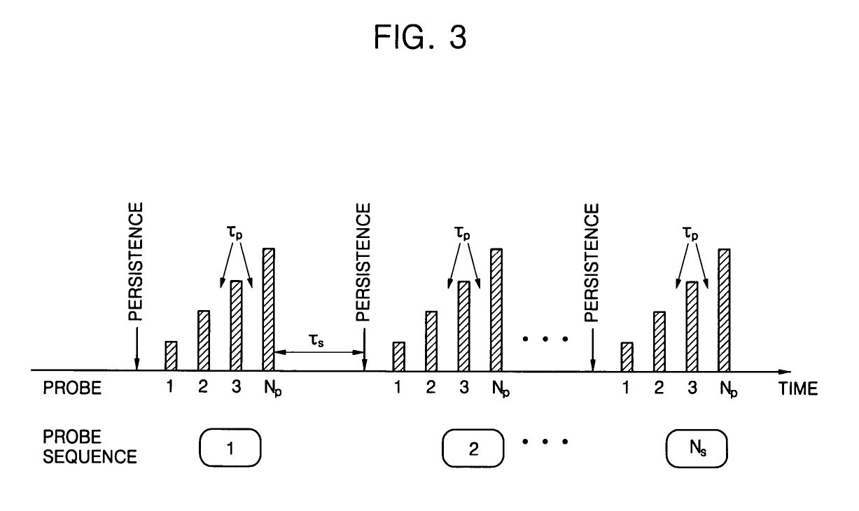

FIG. 3 shows an exemplary access probe sequence of an access channel according to an exemplary embodiment of the present invention.

As shown in FIG. 3, a persistence test is performed to delay an access for a prescribed time before a first probe is transmitted, in order to control congestion of access channels. Also, the persistence test is performed between a series of access probes. If the ANTS designates a congestion probability value called APersistence according to an AT's class to an access parameter message, the AT delays an access time to transmit the access message using the value.

However, if all ATs in receipt of the group call page message use the SSC monitoring method with the same slot and the same PD value as described above, it is quite possible that all the ATs access simultaneously.

To address this problem, the AT applies a transmission delay time which is randomly obtained only for the group call page message excluding a general page message like a 1:1 call. That is, the AT receives an APersistence value transmitted from the ANTS and randomly changes the value, whereby the access times of the ATs become different from one another.

Currently commercialized ANTSs usually transmit with a minimum delay or without any delay to increase access speed. In this example, if a plurality of ATs which are densely located in one sector are paged using one page message, this increases a congestion risk in the access channel. For this reason, ATs receiving the group call page message randomly set the APersistence value used in an upper PD value to avoid congestion between ATs.

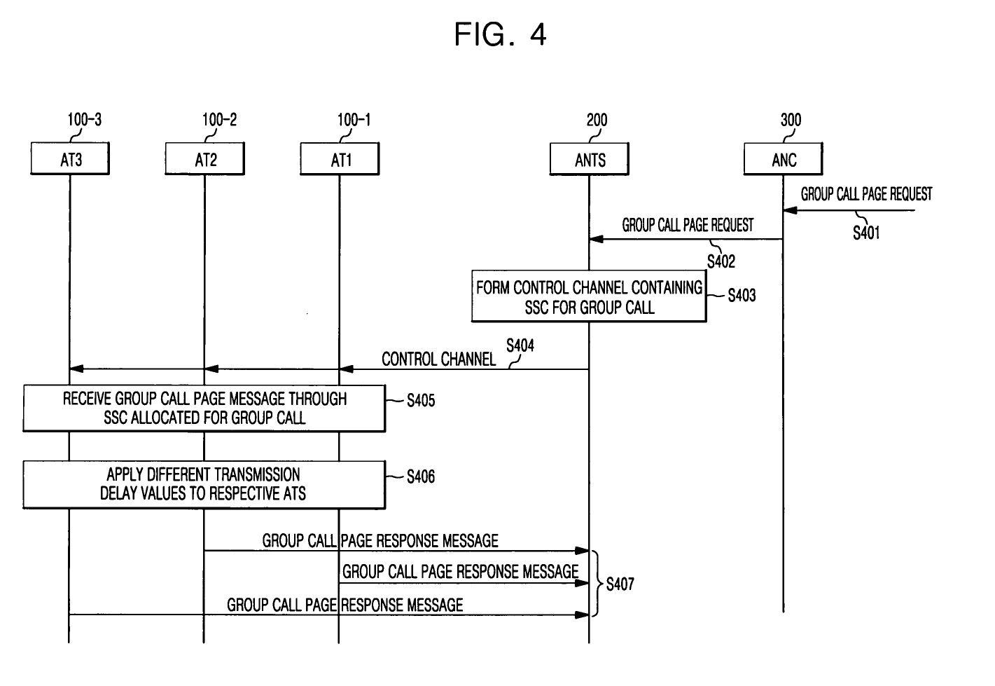

FIG. 4 is a diagram illustrating an exemplary group call paging method in which different transmission delay values are applied to respective ATs according to an exemplary embodiment of the present invention.

First, it is assumed that AT1 100-1, AT2 100-2, and AT3 100-3, which belong to the same group, are located in one ANTS 200 region. If a group call page request for a group to which the three ATs belong is received at the ANTS 200 through the ANC 300 at steps S401 and S402, the ANTS 200 loads a group call page message onto the prescribed SSC to form a control channel at step S403. The ANTS 200 wirelessly transmits the control channel to the ATs at step S404, and the AT1, AT2, and AT3 receive the group call page message through the group call paging SSC at the same time at step S405.

The AT1 100-1, AT2 100-2, AT3 100-3 in receipt of the group call page message apply respectively different transmission delay values to form the group call page response messages at step S406, and then transmit the group call page response message to the ANTS 200 at step S407.

A method for making the AT monitor one SSC within one control channel period is described below.

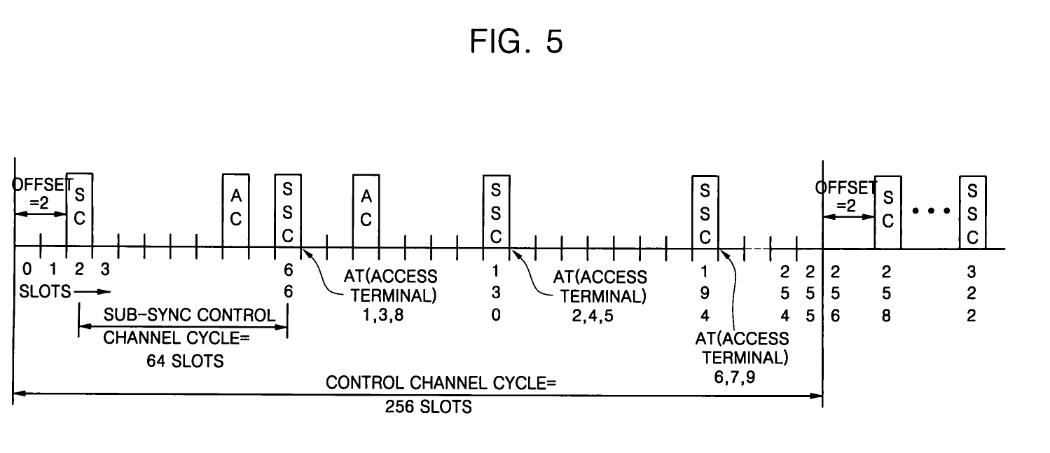

FIG. 5 shows an exemplary control channel for distributing a congestion risk according to an exemplary embodiment of the present invention.

The exemplary embodiment of FIG. 5 is a method for making the AT monitor only one SSC, rather than all SSCs. Various methods can be used for deciding which among the three SSCs the AT should monitor. For example, there is a method for randomly selecting one of the three SSCs using a UATI value of the AT as a factor of a hash function.

In FIG. 5, among the three SSCs included in one control channel, a first SSC is designated to be monitored by AT1, AT3, and AT8, a second SSC is designated to be monitored by AT2, AT4, and AT5, and a third SSC is designated to be monitored by AT6, AT7, and AT9.

Using the method suggested in FIG. 5, a plurality of ATs which are located in the same sector are appropriately distributed to three SSCs to perform monitoring. Thus, if the ATs transmit the group call page response messages over the access channel, a congestion risk is distributed.

In FIG. 5, if the ANTS individually transmits general page messages, rather than the group call page message, to each of the ATs through the SSC, it should not randomly select one among the three SSCs but rather should confirm which SSC slots the AT monitors using the UATI of the AT as a factor of the hash function, and then transmit the page message through the corresponding SSC slot. Here, the group call page message is transmitted through all three SSC slots from the ANTS to the AT.

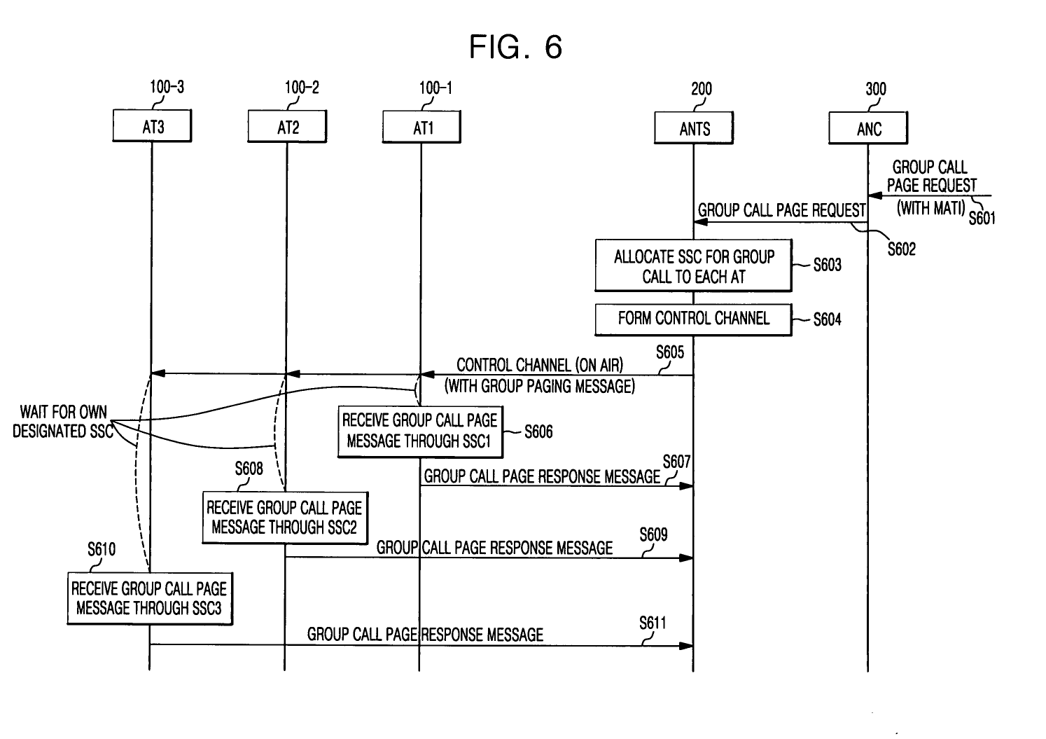

FIG. 6 is a diagram illustrating an exemplary group call paging procedure according to an exemplary embodiment of the present invention.

FIG. 6 shows an operation between the ANTS and the AT where group call paging is performed according to the method described in FIG. 5. In FIG. 6, it is assumed that AT1 100-1, AT2 100-2, and AT3 100-3, which belong to the same group, are located in one ANTS 200 region.

If a group call paging request for a certain group using the MATI as the group call identifier is transmitted to the ANTS 200 through the ANC 300 at steps S601 and S602, the ANTS 200 allocates SSCs for the group call paging to the respective ATs at step S603. At this time, allocation of the SSCs is performed such that many ATs are not concentrated on one SSC but are evenly distributed. In this exemplary embodiment of FIG. 6, it is assumed that one SC comprises three SSCs, and an SSC1 is allocated to the AT1 100-1, an SSC2 is allocated to the AT2 100-2, and an SSC3 is allocated to the AT3 100-3.

The ANTS 200 forms a control channel containing the group call page message based on the allocated SSCs at step S604, and wirelessly transmits the control channel at step S605. The ATs which belong to the paged group wait for and then monitor their own designated SSC. Of these, the AT1 100-1 first receives the group call page message at step S606. This is because the AT1 100-1 monitors the SSC1 which comes first among the three SSCs. The AT1 100-1 which is the first to receive the group call page message transmits the group call page response message to the ANTS 200. Then, the AT2 100-2 which monitors the SSC2 receives the group call page message at step S608. The AT2 100-2 also transmits the group call page response message to the ANTS 200 at step S609. Finally, the AT3 100-3 receives the group call page message through the SSC3 at step S610 and then transmits the group call page response message to the ANTS 200 at step S611.

As described above, the AT1 to AT3 100-1 to 100-3 have different times for monitoring the respective SSCs and thus have different response times. In this method, it is possible to avoid congestion of group call page response messages simultaneously transmitted from several ATs to the ANTS.

In the exemplary embodiment of FIGS. 5 and 6, to receive the general page message eventually follows the SSC monitoring period, and thus there is a disadvantage in that it is difficult to reduce an access delay time obtained by using the SSC to increase the PTT incoming speed. However, the probability of the ANTS successfully receiving the group call page response message responsive to the group call page message is increased, so that it is possible to more accurately perceive how many ATs are located in one sector.

Also, the number of ATs which are located in one sector detected by the above-described method is used as a reference for determining whether to provide a unicast type service which allocates discrete traffic resources for respective ATs or a multicast type service which shares one traffic resource to increase capacity.

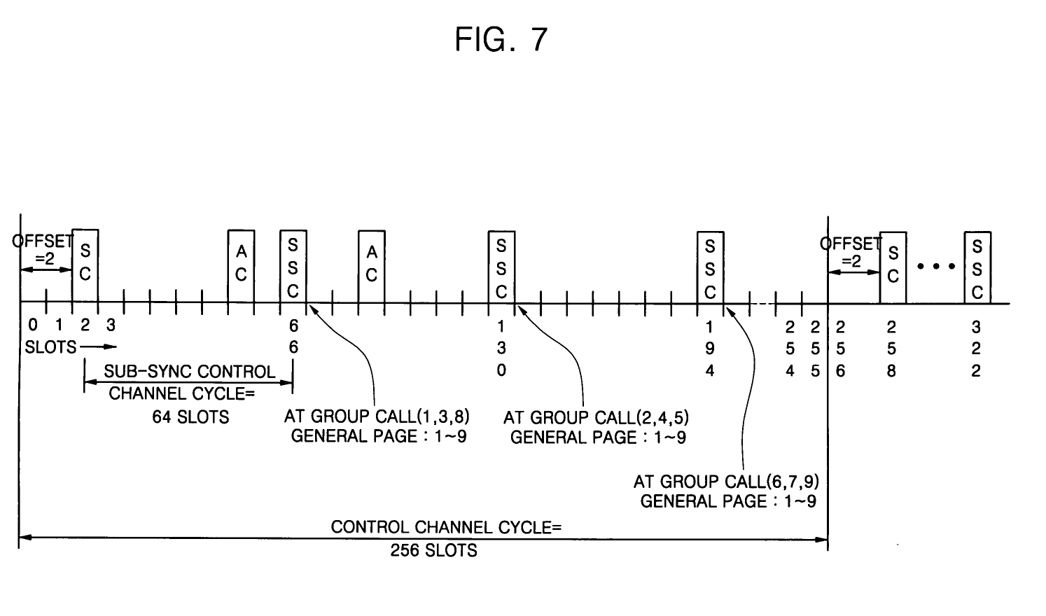

FIG. 7 shows an exemplary control channel according to an exemplary embodiment of the present invention.

FIG. 7 provides an exemplary method for designating one of the three SSCs as a SSC slot which the AT recognizes as the effective group call page message while maintaining a structure in which the AT monitors all SSC slots within one control channel period as described above.

That is, 9 ATs of FIG. 7 monitor all of SSC1, SSC2 and SSC3, but AT1, AT3, and AT8 effectively receive the group call page message through the SSC1, AT2, AT4, and AT5 effectively receive the group call page message through the SSC2, and AT6, AT7, and AT9 effectively receive the group call page message through the SSC3. In the case of the general page message, rather than the group call page message, it can be understood from FIG. 7 that 9 ATs each monitor all SSCs and receive the corresponding page messages.

The general page is based on SSC slots having a 64-slot period, but the SSC slot for the group call page message has a 256-slot period like an SC. That is, this exemplary embodiment has the advantages of both SSC slot monitoring methods described above. Accordingly, the ANTS transmits the group call page message through one of the successive SSC slots. Thus, the AT recognizes the group call page message received through one of the successive SSC slots as effective.

This exemplary method distributes the response message congestion probability in the access channel by setting the group call paging period to a 256-slot while maintaining transmission speed of the existing page message to a period between SSC slots, i.e., 64 slots. Of course, the AT receives the group call page message even when monitoring other slots to receive the general page message. In this case, the AT ignores the group call page message if the corresponding SSC slot is not a monitoring slot for the group call page message allocated to it.

After the access network including the ANTS perceives the number of the group call page response messages responsive to the group call page message which are transmitted from the ATs, a procedure for determining whether to process the corresponding message by group call paging or general call paging is needed.

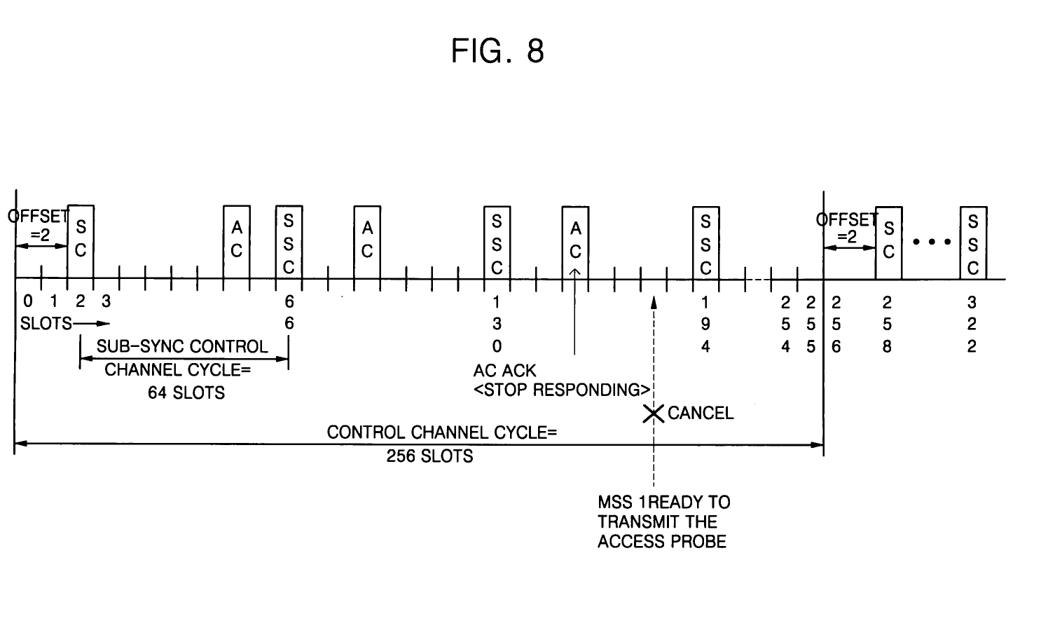

FIG. 8 shows an exemplary control channel for requesting to stop transmitting group call page response messages according to an exemplary embodiment of the present invention.

A message of requesting to stop transmitting group call page response messages is transmitted from the AT to the ANTS through an AC channel of FIG. 8. As shown in FIG. 8, the AC channel does not have a prescribed period and is formed at any time if the AT has a message to send to the ANTS.

When ATs located in one sector of the ANTS and desiring to participate in a certain group call successfully transmit the group call page response messages by the above-suggested methods, the ANTS does not need the group call page response message from ATs if the number of ATs in one sector set to allocate a group traffic resource for a group call exceeds a prescribed threshold or is basically set to use a shared traffic resource for a group call instead of a unicast method. That is, the message of requesting to stop transmitting group call page response messages is transmitted from the ANTS to inform the ATs which do not transmit the group call page response message that they do not need to transmit the group call page response messages.

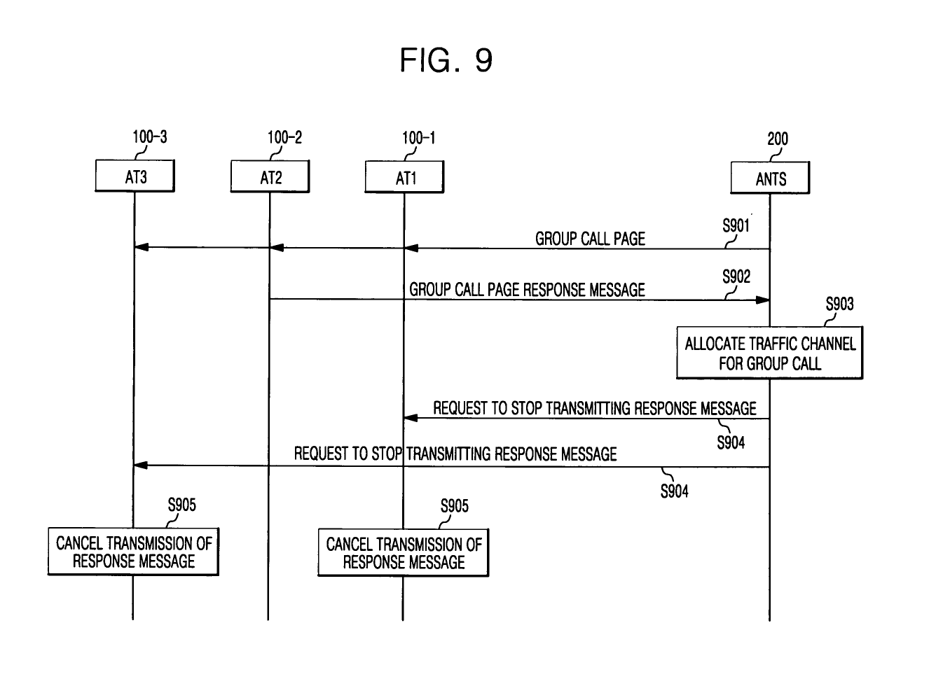

FIG. 9 is a diagram illustrating an exemplary procedure for requesting the stopping of group call page response message transmission to ATs in the process of preparing transmission of the group call page response message according to an exemplary embodiment of the present invention.

In FIG. 9, it is assumed that 3 ATs which belong to the same group are located in an ANTS sector.

The ANTS 200 receives a group call page request from the network and performs the group call paging for AT1 100-1, AT2 100-2 and AT3 100-3 which belong to the corresponding group at step S901. Among the ATs in receipt of the group call page message, the AT2 100-2 first transmits the group call page response message to the ANTS 200 at step S902, and the ANTS 200 receives the group call page response message and allocates a traffic channel for a group call at step S903.

Here, the ANTS transmits an AC Ack (acknowledge) message to the AT1 100-1 and the AT3 100-3 which are preparing transmission of the group call page response message through the asynchronous control channel capsule (AC) to request the stopping of the group call page response message transmission at step S904. The ATs in receipt of the AC Ack message cancel the group call page response message transmission at step S905 and regard the group call page response message as successfully transmitted.

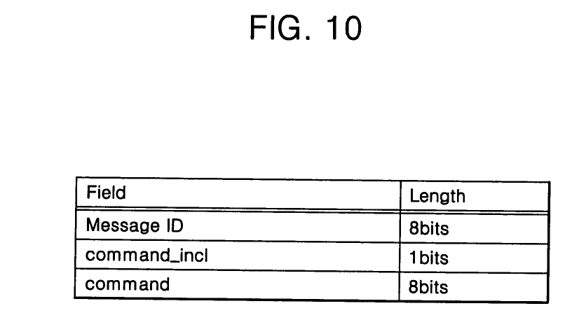

FIG. 10 shows an exemplary structure of the AC Ack message used for the group call page response message transmission stop request according to an exemplary embodiment of the present invention.

The ANTS adds a command to the existing AC Ack message to request stop of the group call page response message transmission as shown in FIG. 10. In FIG. 10, a “Message ID” field represents an ID given to the corresponding message, and a “command_incl” field is a field which is set to “1” only if the ANTS desires to transmit a certain command to the AT. If there is no certain command, the “command_incl” field is omitted. A “command” field has a value if “command_incl” field is set to “1”. In this exemplary embodiment, the “command” field set to “00000001” is defined as a command to stop the group call page response message transmissions. “00000010”˜“11111111” are reserved for other commands.

The MATI allocated to a group is used as an address value, and among the ATs in receipt of the Ac Ack message, the AT which is in the process of preparing transmission of the access probe stop transmission operation. After the transmission is stopped, those among the group call page messages received through the SSC comprising the original group call page message or the other SSCs within one control channel period that were requested before the transmission is stopped are ignored.

As described above, the mobile communication system according to exemplary embodiments of the present invention can more effectively control the group call by providing a method for transmitting one group call page message using the MATI instead of transmitting individual group call messages, transmitting a group call related message to all ATs through one group call page message in the state that all ATs monitor the same SSC slot, making the AT apply a random delay value to the persistence test to avoid congestion which may occur when ATs located in the same sector and desiring to participate in a group call simultaneously transmit the group call page response message, and requesting the ATs to stop transmission of the group call page response message when the ANTS does not need to receive the group call page response message.

While the present invention has been described with reference to exemplary embodiments thereof, it will be understood by those skilled in the art that various changes in form and detail may be made therein without departing from the scope of the present invention as defined by the following claims

What is claimed is:

1. A method for controlling congestion between response messages responsive to a group call page in a mobile communication system, comprising:
transmitting a group call page message comprising a group call identifier to at least one group call paging target access terminal through a control channel;
receiving the group call page message at the at least one access terminal; and
applying, at the at least one access terminal, a different response time according to a reception type of the group call page message and transmitting a response message to an access network transceiver system.

2. The method of claim 1, wherein the group call identifier is transmitted to the at least one access terminal, and at least one of a page message, a location check request message RouteUpdateRequest, and a DataOverSignaling message comprises the group call identifier.

3. The method of claim 1, wherein the group call identifier comprises a multicast access terminal identifier (MATI).

4. The method of claim 1, wherein the group call page message is transmitted to the at least one access terminal through a sub-synchronous control channel capsule (SSC).

5. The method of claim 4, wherein the group call page message is transmitted to all of the group call paging target access terminals through one SSC designated for a group call page among SSC slots included in one control channel period.

6. The method of claim 5, whereineach of the at least one access terminal changes a fixed transmission delay time (APersistence) value received from the access network transceiver system into a random value, and transmit the response message to the access network transceiver system at a different access time from other access terminals.

7. The method of claim 4, wherein in transmitting a group call page message, one SSC slot is designated for the respective access terminals as a SSC slot for a group call page, and the group call page message is transmitted through the designated SSC slot.

8. The method of claim 7, wherein receiving the group call page message comprises monitoring only the SSC slot designated to the access terminal to receive the group call page message.

9. The method of claim 7, wherein receiving the group call page message comprises:
monitoring all SSC slots; and
receiving the group call page message only through a designated SSC slot of the access terminal.

10. The method of claim 7, wherein the SSC slot for the group call page is designated for respective access terminals using a value obtained using a unicast access terminal identifier (UATI) as a factor of a hash function.

11. The method of claim 1, further comprising:
transmitting a stop request message for requesting the at least one access terminals which is in the process of preparing transmission of the response message to stop transmission of the response message when the access network transceiver system in receipt of the response message from the at least one access terminal performs a group call page.

12. The method of claim 11, further comprising:
adding the stop request message to an AC Ack message of an asynchronous control channel capsule (AC); and
transmitting the stop request message to the access terminal.

13. A method for controlling congestion between response messages responsive to a group call page in a mobile communication system, the method comprising:
transmitting a group call page message comprising a group call identifier to at least one group call paging target access terminal through a control channel with a time difference;
receiving the group call page message at the at least one access terminal;
transmitting, at the at least one access terminal, a response message to an access network transceiver system according to a reception type of the group call page message;
transmitting a stop request message for requesting the at least one access terminal which is in the process of preparing transmission of the response message to stop transmission of the response message when the access network transceiver system in receipt of the response message from the at least one access terminal performs a group call page; and
canceling transmission of the group call page response message at the at least one access terminal in receipt of the stop request message.

14. A method for controlling congestion between response messages responsive to a group call page in a mobile communication system, the method comprising:
transmitting, at an access network transceiver system, a group call page message comprising a group call identifier to an access terminal through a control channel; and
applying, at the at least one access terminal in receipt of the group call page message, a different transmission delay value from other access terminals and transmitting a response message to the access network transceiver system.

15. The method of claim 14, wherein the access terminal in receipt of the group call page message changes a fixed transmission delay time (APersistence) value received from the access network transceiver system into a random value to have a different access time from other access terminals.

16. A mobile communication system, comprising:
an access network transceiver system for transmitting a group call page message comprising a group call identifier to at least one group call paging target access terminal through a control channel; and
at least one access terminal for receiving the group call page message, applying a different response time from other access terminals according to a reception type of the received group call page message, and transmitting a response message to the access network transceiver system.

17. The system of claim 16, wherein at least one of a page message, a location check request message RouteUpdateRequest, and a DataoverSignaling message comprises the group call identifier.

18. The system of claim 16, wherein the group call identifier comprises a multicast access terminal identifier (MATI).

19. The system of claim 16, wherein the group call page message is transmitted to the access terminal through a sub-synchronous control channel capsule (SSC).

20. The system of claim 18, wherein the access network transceiver system transmits the group call page message to all of the group call paging target access terminals through one SSC designated for a group call page among SSC slots, wherein one control channel period comprises the SSC slots, and wherein all of the group call paging target access terminals monitor the SSC slot designated for the group call to receive the group call page message.

21. The system of claim 19, wherein the access network transceiver system designates one SSC slot for each access terminal as a SSC slot for a group call page and transmits the group call page message to the access terminals through the designated SSC slots, and each access terminal monitors only the SSC slot designated for the access terminal to perceive whether the group call page message is received.

22. The system of claim 21, wherein the access terminal monitors all SSC slots and receives the group call page message only through a designated SSC slot of the access terminal.

23. The system of claim 21, wherein one SSC among SSC slots of one control channel period is designated as the SSC slot for the group call page using a value obtained using a unicast access terminal identifier (UATI) of the access terminal as a factor of a hash function.

24. The system of claim 16, wherein the access network transceiver system transmits a stop request message for requesting the at least one access terminal which is in the process of preparing transmission of the response message to stop transmission of the response message when the access network transceiver system in receipt of the response message from the at least one access terminal performs a group call page.

25. The system of claim 24, wherein an AC Ack message of an asynchronous control channel capsule (AC) comprises the stop request message and is transmitted to the access terminal.

26. An access terminal for controlling congestion in a mobile communication system which supports a group call, the access terminal comprising:
a receiver for receiving a group call page message from an access network transceiver system, and changing a fixed transmission delay time value received from the access network transceiver system to a random value; and
a transmitter for transmitting a group call page response message to the access network transceiver system at a different access time from other access terminals.

27. An access network transceiver system of a mobile communication system which supports a group call, the system comprising:
the access network transceiver for designating one of SSC slots contained within one control channel period as a SSC slot for a group call page, and transmitting a group call page message comprising a group call identifier through the designated SSC slot to at least one group call paging target access terminal to perform a group call page.

28. The system of claim 27, wherein the group call identifier comprises a multicast access terminal identifier (MATI).

29. The system of claim 27, wherein one SSC slot for each access terminal is designated as the SSC slot for the group call page and the group call page message is transmitted to the access terminals through the designated SSC slot.

30. The system of claim 27, wherein the access network transceiver system transmits a stop request message for requesting the at least access terminal which is in the process of preparing transmission of the response message to stop transmission of the response message when the access network transceiver system receives the response message from the at least one access terminal and performs the group call page.

31. The system of claim 30, wherein an AC Ack message of an asynchronous control channel capsule (AC) comprises the stop request message and is transmitted to the access terminal.
